(19) United States
(12) Patent Application Publication
(10) Pub. No.: US 2026/0216626 A1
(43) Pub. Date: Jul. 30, 2026

(54) WATER FILTER AND ADAPTER FOR WATER FILTER

(71) Applicant: LG ELECTRONICS INC., Seoul (KR)

(72) Inventor: Jongpil KIM, Seoul (KR)

(21) Appl. No.: 19/428,856

(22) Filed: Dec. 22, 2025

(30) Foreign Application Priority Data
Jan. 24, 2025 (KR) 10-2025-0011431

(51) Int. Cl. B01D 35/30

(52) U.S. Cl. CPC B01D 35/306; B01D 2201/302; B01D 2201/304; B01D 2201/4053

(57) ABSTRACT

The present invention relates to a water filter and an adapter for a water filter. A water filter according to an embodiment of the present invention is detachably coupled to a head connected to a water supply source and includes a filter housing accommodating a filter member for water purification, a filter cap covering an open upper surface of the filter housing and having a protruding inlet port and a protruding outlet port, and an adapter coupled to an upper end of the filter cap. In a state in which the adapter is coupled to the filter cap, the adapter is rotatably coupled to the head so that the inlet port and the outlet port are placed in communication with a flow path inside the head.

### CROSS-REFERENCE TO RELATED APPLICATIONS

The present application claims priority under 35 U.S.C. 119 and 35 U.S.C. 365 to Korean Patent Application No. 10-2025-0011431 (January 24, 2025), which is hereby incorporated by reference in its entirety.

### BACKGROUND

The present disclosure relates to a water filter and adapter for water filter.

Generally, a filter device or a home appliance equipped with a filter device may include a head provided on a flow path through which water flows, and a filter detachably coupled to the head and having a filter member for water purification incorporated therein. Depending on the type of the filter member, the filter device may exhibit various water purification performances, and the filter device may be configured by a combination of a plurality of filters having different types of filter members.

Such a filter device requires periodic replacement in order to maintain water purification performance, and may be configured to have a structure that facilitates replacement so that a user can easily replace the filter at a desired time.

Accordingly, the filter device may have a structure that allows convenient mounting and detachment, and in particular, various structures have been developed in which incorrect mounting is prevented by a coupling structure between the head and the filter, and accurate mounting is ensured.

In addition, a filter device has been developed in which an internal flow path of the head is switched by rotation of the filter during a process in which the filter is detached from the head, thereby preventing leakage even when the filter is separated.

However, in such a filter device, there is a problem in that an internal flow path structure of the head for switching the flow path is complex. In addition, when switching of the flow path is repeatedly performed, durability of the head is degraded, which may result in leakage.

### SUMMARY

A water filter according to an embodiment of the present invention is a water filter detachably coupled to a head connected to a water supply source, and includes a filter housing accommodating a filter member for water purification, a filter cap covering an open upper surface of the filter housing and provided with an inlet port and an outlet port, and an adapter coupled to the filter cap. In a state in which the adapter is coupled to the filter cap, the adapter is rotatably coupled to the head so that the inlet port and the outlet port can be communicated with a flow path inside the head.

The adapter may include an outer member forming an outer surface, the outer member having an open upper surface and an open lower surface and defining a hollow space, and an inner member disposed inside the hollow space and coupled to the inlet port and the outlet port. The outer member is rotatably coupled to the head by rotating with respect to the inner member, and, during rotational coupling of the outer member, the inner member moves upward in a non-rotating state.

The outer member may include an upper part inserted into an interior of the head and rotatably coupled to the head, and a lower part extending downward from a lower end of the upper part, the lower part being exposed below the head and configured to be rotationally operated by a user.

An outer diameter of the lower part may be formed to be larger than an outer diameter of the inner member.

A coupling portion protruding outward and rotatably coupled to the head may be formed on an outer surface of the upper part, and, as the outer member rotates, the coupling portion may move upward along the head.

A plurality of operation portions configured to rotate the outer member may be provided on an outer surface of the lower part.

Each operation portion may include a first part protruding in a circumferential direction from an outer surface of the lower part, and a second part protruding upward from the lower part.

A fastening hook protruding inward may be provided on the outer member, and a rotation groove into which the fastening hook is inserted may be formed on the inner member. The rotation groove may be formed along a periphery of the inner member so as to guide movement of the fastening hook during rotation of the outer member.

A fastening groove extending to communicate with the rotation groove may be formed on an outer surface of the inner member, and the fastening groove may be formed to have a size corresponding to the fastening hook so as to guide the fastening hook to move into the rotation groove.

The inner member may be disposed inside the outer member, and an upper end and a lower end of the inner member may be positioned between an upper end and a lower end of the outer member.

The inner member may include a port receiving portion opened downward and configured to receive the inlet port and the outlet port, and an inlet portion and an outlet portion protruding upward from an upper surface of the inner member and configured to be inserted into the head, and the inlet portion and the outlet portion may communicate with the port receiving portion.

O-rings may be provided on outer surfaces of the inlet port and the outlet port, and the O-rings may be press-fitted against inner surfaces of the port receiving portion so as to maintain a state in which the adapter is coupled to the filter cap.

A filter coupling portion protruding upward may be formed on an upper surface of the filter cap, and a coupling hole configured to receive the filter coupling portion may be formed in a lower surface of the inner member. Coupling between the filter coupling portion and the coupling hole may maintain the inner member in a state of being coupled to the filter cap.

The inlet port and the outlet port may contact each other to form a single port portion inserted into the port receiving portion, and the inlet portion and the outlet portion may branch from the port receiving portion.

The port receiving portion may include an inlet port receiving portion configured to receive the inlet port and an outlet port receiving portion configured to receive the outlet port, and the inlet portion may communicate with an upper surface of the inlet port receiving portion, and the outlet portion may communicate with the outlet port receiving portion.

An adapter for a water filter according to an embodiment of the present invention includes an outer member having an open upper surface and an open lower surface and defining a hollow space, the outer member being rotatably coupled to a head of a household appliance, and an inner member disposed inside the hollow space and connected to an inlet port and an outlet port of a water filter. The outer member rotates with respect to the inner member, and, during rotational coupling of the outer member, the inner member moves upward and downward so as to connect the inlet port and the outlet port to a flow path of the head.

A fastening hook protruding inward may be provided on the outer member, and a rotation groove into which the fastening hook is inserted may be formed on the inner member. The rotation groove may be formed along a periphery of the inner member so as to guide movement of the fastening hook during rotation of the outer member.

A coupling portion configured to be rotatably coupled to the head may be formed on an outer surface of the outer member.

An operation portion configured for rotational operation of the outer member may be provided on an outer surface of the outer member at a position located below the coupling portion.

The operation portion may protrude outward below the head, and a plurality of operation portions may be formed radially with respect to a center of the outer member.

The details of one or more embodiments are set forth in the accompanying drawings and the description below. Other features will be apparent from the description and drawings, and from the claims.

### BRIEF DESCRIPTION OF THE DRAWINGS

FIG. 1 is a view illustrating a flow path structure for supplying water to a refrigerator according to an embodiment of the present invention.

FIG. 2 is an exploded perspective view illustrating a state in which a water filter according to an embodiment of the present invention is separated from a head.

FIG. 3 is an exploded perspective view of a head body of the head.

FIG. 4 is a bottom view of the head body.

FIG. 5 is a perspective view illustrating a state in which the water filter and an adapter are coupled to each other.

FIG. 6 is an exploded perspective view illustrating a state in which the water filter and the adapter are separated from each other.

FIG. 7 is a perspective view of the adapter as viewed from above.

FIG. 8 is a perspective view of the adapter as viewed from below.

FIG. 9 is an exploded perspective view of the adapter.

FIG. 10 is a cutaway perspective view of the adapter.

FIG. 11 is a longitudinal cross-sectional view of the water filter.

FIG. 12 is a cutaway perspective view illustrating a flow of water in a state in which the water filter is mounted.

FIG. 13 (a) to (d) are views illustrating a process of mounting the water filter in a step-by-step manner.

FIG. 14 is a view illustrating a state of the adapter inside the head when the adapter is rotated.

FIG. 15 is a view illustrating a state of the adapter inside the head when mounting of the water filter is completed.

FIG. 16 is an exploded perspective view illustrating a state in which a water filter and an adapter according to another embodiment of the present invention are separated from each other.

FIG. 17 is a partial cross-sectional view illustrating a coupling structure between the water filter and the adapter.

FIG. 18 is an exploded perspective view illustrating a state in which a water filter and an adapter according to still another embodiment of the present invention are separated from each other.

FIG. 19 is a partial cross-sectional view illustrating a coupling structure between the water filter and the adapter.

### DETAILED DESCRIPTION OF THE EMBODIMENTS

Hereinafter, specific embodiments of the present invention will be described in detail with reference to the accompanying drawings. However, the present invention is not limited to the embodiments disclosed herein in which the spirit of the present invention is presented, and other embodiments falling within the scope of the spirit of the present invention may be readily proposed through addition, modification, or deletion of other components, or through other non-retrogressive variations.

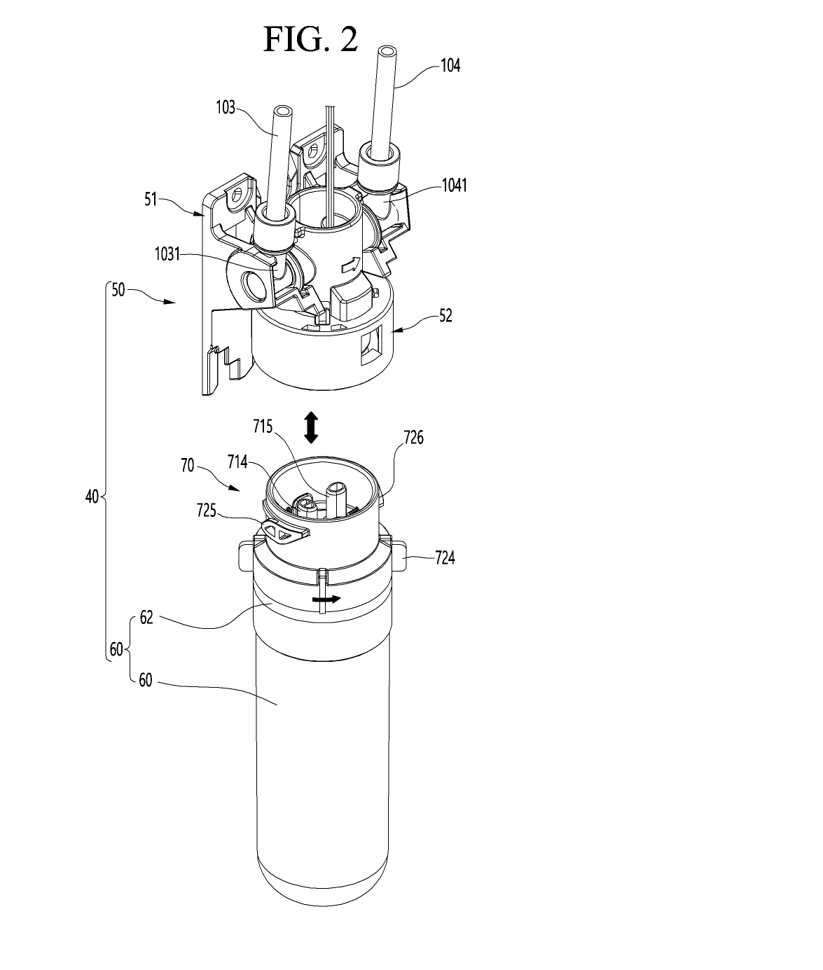

Prior to the description, directions are defined. In an embodiment of the present invention, as illustrated in FIG. 2, a direction toward the head may be referred to as an upward direction, a direction toward the water filter may be referred to as a downward direction, a direction toward a mounting member may be referred to as a rearward direction, and a direction away from the mounting member may be referred to as a forward direction. In addition, a direction toward a center of the filter and the head may be referred to as an inward direction, and a direction away from the center may be referred to as an outward direction.

Further, although an embodiment of the present invention will be described by taking a refrigerator as an example among various home appliances, it should be understood in advance that the water filter according to an embodiment of the present invention is not limited to the refrigerator, and may be applied to various home appliances that require water purification, such as a water purifier, an ice maker, and the like, without limitation to structure or form.

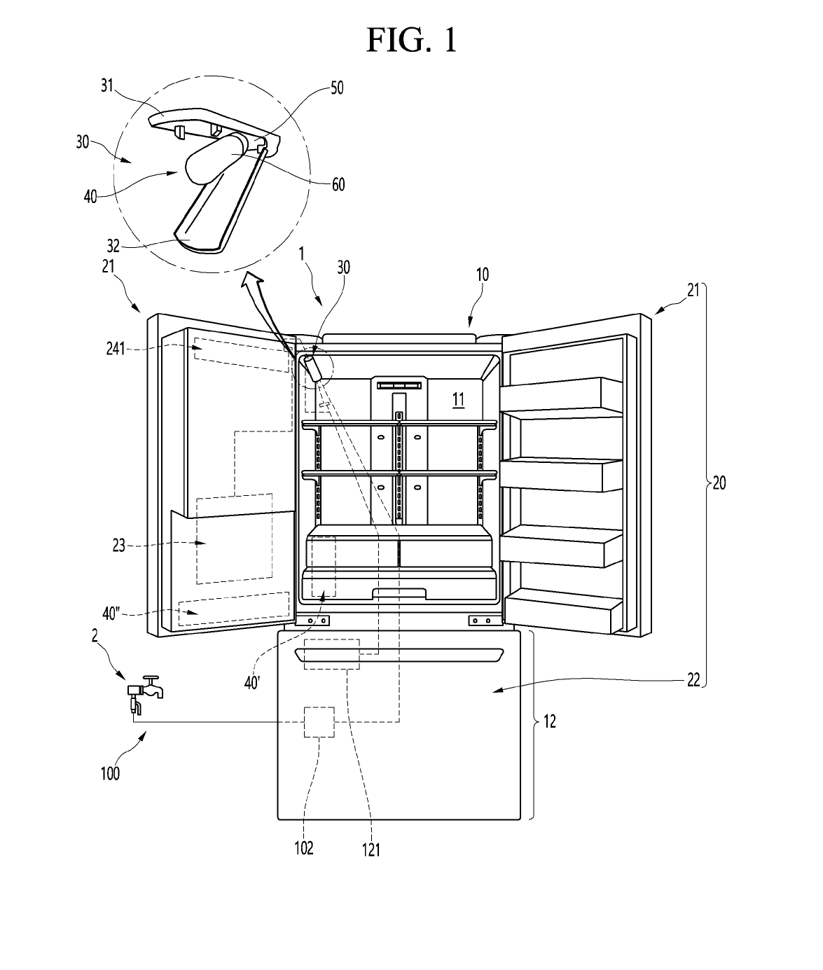

FIG. 1 is a view illustrating a flow path structure for supplying water to a refrigerator according to an embodiment of the present invention.

As illustrated, a refrigerator 1 according to an embodiment of the present invention may have an outer appearance defined by a cabinet 10 forming a storage space and doors 20 configured to open and close the storage space of the cabinet 10.

The storage space may include a refrigerating compartment 11 disposed in an upper portion of the cabinet 10 and a freezing compartment 12 disposed in a lower portion of the cabinet 10.

The doors 20 may include a refrigerating compartment door 21 configured to open and close the refrigerating compartment 11 and a freezing compartment door 22 configured to open and close the freezing compartment 12 independently of each other. The refrigerating compartment door 21 may be provided as a pair on left and right sides and may be configured to open and close the refrigerating compartment 11 by rotation. Further, the freezing compartment door 22 may have a drawer-type structure and may be configured to open and close the freezing compartment 12 by being drawn in and out. The present invention is not limited to a type or form of the refrigerator and may be applicable to various types of refrigerators.

A dispenser 23 through which purified water or ice is dispensed and an ice maker 241 may be provided in one of the pair of refrigerating compartment doors 21. In addition, an ice maker 121 may be provided inside the freezing compartment 12.

The refrigerator 1 may include a filter assembly 40 for purifying water supplied from an external water supply source 2. The water supply source 2 may be a water supply line or a water tank provided inside or outside the refrigerator 1.

Water supplied from the water supply source 2 may be purified by the filter assembly 40 and then dispensed through the dispenser 23 or supplied to the ice makers 241 and 121. The water supply source 2, the filter assembly 40, the dispenser 23, and the ice makers 241 and 121 may be connected to each other by a water supply flow path 100.

The filter assembly 40 may be provided at one of left and right corners of an upper surface of the refrigerating compartment 11. As another example, the filter assembly 40′ may be provided between storage members such as drawers or shelves of the refrigerating compartment 11, or at a rear position that is hidden by the storage members. As still another example, the filter assembly 40″ may be provided on the refrigerating compartment door 21.

Meanwhile, a filter device 30 may be provided in the refrigerating compartment 11. The filter device 30 may include a case 31 mounted to the cabinet 10, a cover 32 configured to open and close the case 31, and the filter assembly 40 mounted inside the case 31 and exposed when the cover 32 is opened.

The filter assembly 40 may include a filter 60 and a head 50. Further, when the cover 32 is opened, the filter 60 may be exposed forward so as to be easily detached. The filter 60 is used for water purification and may be referred to as a water filter.

Hereinafter, a structure of the filter assembly 40 will be described in more detail with reference to the drawings.

FIG. 2 is an exploded perspective view illustrating a state in which a water filter according to an embodiment of the present invention is separated from a head.

As illustrated, the filter assembly 40 may include a head 50 and a filter 60 detachably mounted to the head 50.

The head 50 may include a mounting member 51 for mounting the filter assembly 40, and a head body 52 to which the filter 60 is detachably coupled. Meanwhile, when a structure for mounting the head 50 is provided in the refrigerator 1, the mounting member 51 may be omitted.

In a state in which the filter 60 is mounted, the head body 52 may be rotated with respect to the mounting member 51 so as to facilitate attachment and detachment of the filter 60. In addition, an inlet pipe fitting 1031 connected to an inlet pipe 103 and an outlet pipe fitting 1041 connected to an outlet pipe 104 may be provided on opposite sides of the head body 52.

An outer appearance of the filter 60 may be formed by a filter housing 61 and a filter cap 66. Further, the filter 60 may further include an adapter 70. The adapter 70 may be coupled to an upper end of the filter 60. In a state in which the adapter 70 is coupled to the upper end of the filter 60, the adapter 70 may be detachably mounted to the head 50.

The adapter 70 may be coupled to the head 50 by rotation. A coupling portion 725 and 726 configured to be rotatably coupled to the head 50 may be formed on an outer surface of the adapter 70. As an example, the coupling portion 725 and 726 may include a first guide protrusion 725 and a second guide protrusion 726 disposed at positions facing each other. However, the coupling portion 725 and 726 is not limited to a structure including a pair of guide protrusions 725 and 726, and various other structures capable of rotational coupling may also be employed.

An inlet portion 714 and an outlet portion 715 may be formed in the adapter 70. Water for purification may be supplied toward the filter 60 through the inlet portion 714, and purified water from the filter 60 may be discharged through the outlet portion 715.

The inlet portion 714 and the outlet portion 715 may be provided inside the adapter 70 and may be exposed through an open upper surface of the adapter 70. When the adapter 70 is rotatably coupled to the head 50, the inlet portion 714 and the outlet portion 715 may move axially upward so as to be in fluid communication with a flow path inside the head 50.

Hereinafter, the head 50 will be described in more detail with reference to the drawings.

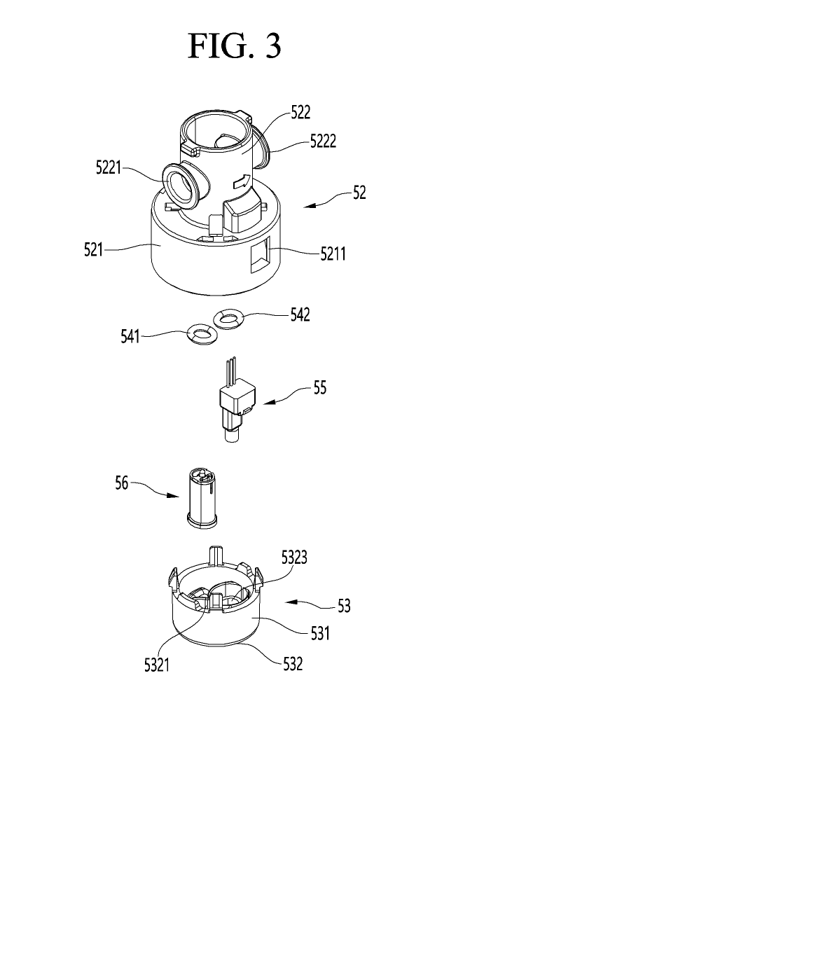

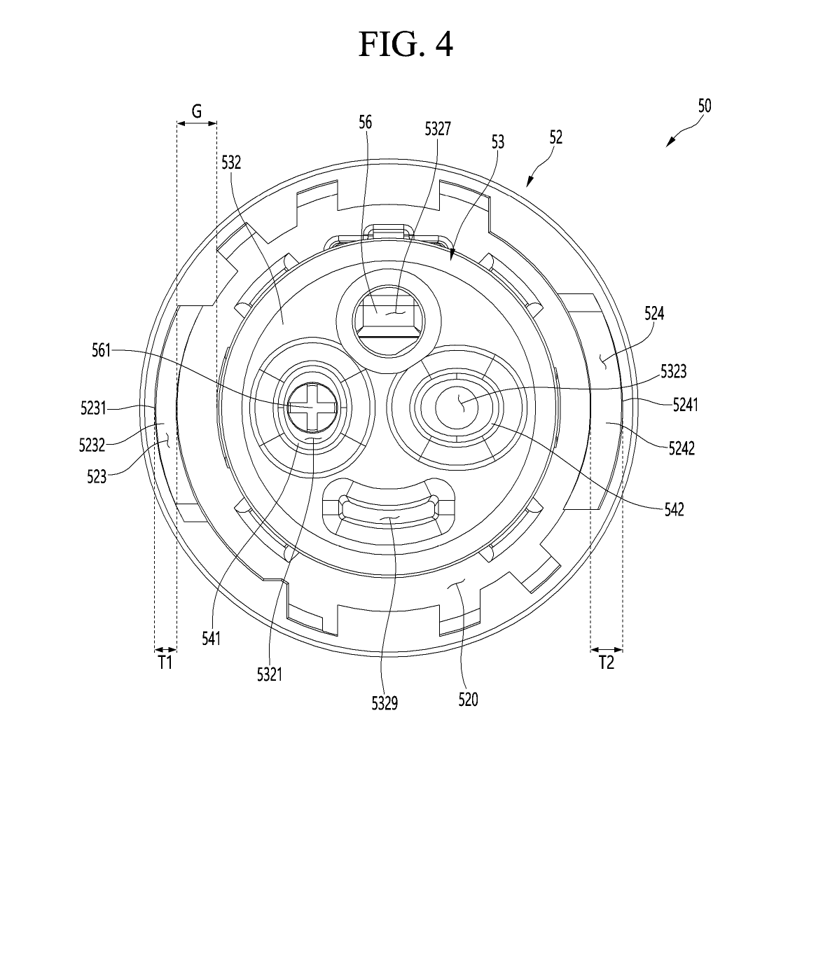

FIG. 3 is an exploded perspective view of a head body of the head, FIG. 4 is a bottom view of the head body.

As illustrated, the head 50 may include the head body 52 to which the filter 60 is detachably mounted.

The head body 52 may include a head upper 522 and a head lower 521. An inlet pipe connection portion 5221 connected to the inlet pipe fitting 1031 and an outlet pipe connection portion 5222 connected to the outlet pipe fitting 1041 may be formed on opposite sides of the head upper 522. Further, the head body 52 may be rotatably disposed on the mounting member 51 with the inlet pipe fitting 1031 and the outlet pipe fitting 1041 serving as rotational axes.

A lower surface of the head lower 521 may be open to form a coupling space 520 to which an upper end of the filter 60 is coupled. In addition, a confirmation window 5211 may be opened at a central portion of a front surface of the head lower 521.

Further, coupling guides 523 and 524 may be recessedly formed on an inner surface of the head lower 521 to guide insertion and coupling of the filter 60. As an example, the coupling guides 523 and 524 may include a first guide 523 and a second guide 524. The first guide 523 may be configured to guide insertion and coupling of the first guide protrusion 725 formed on the adapter 70, and the second guide 524 may be configured to guide insertion and coupling of the second guide protrusion 726 formed on the adapter 70. The first guide 523 may extend to the confirmation window 5211 such that the first guide protrusion 725 is moved axially upward along the first guide 523 up to the confirmation window 5211.

The first guide 523 may include a first guide hole 5231 that is open at a lower end of the head lower 521 and into which the first guide protrusion 725 is inserted. In addition, the first guide 523 may include a first guide portion 5232 that extends obliquely from one end of the first guide hole 5231 toward the confirmation window 5211.

The second guide 524 may be formed at a position facing the first guide 523. In addition, the second guide 524 may be formed to have a shape corresponding to that of the first guide 523.

The second guide 524 may include a second guide hole 5241 that is open at a lower end of the head lower 521 and into which the second guide protrusion 726 is inserted. In addition, the second guide 524 may include a second guide portion 5242 that extends obliquely from one end of the second guide hole 5241 to a central portion of a rear surface of the head lower 521.

The first guide portion 5232 and the second guide portion 5242 may be formed along a periphery of an inner surface of the head lower 521. The first guide protrusion 725 and the second guide protrusion 726 may move while being in contact with the first guide portion 5232 and the second guide portion 5242, respectively.

Meanwhile, a head inner 53 may be coupled inside the head body 52. The head inner 53 may be exposed through the open lower surface of the head body 52. The head inner 53 may be formed with an inlet hole 5321 and an outlet hole 5323 into which the inlet portion 714 and the outlet portion 715 are inserted. In addition, the head inner 53 may be provided with an inlet ring 541 and an outlet ring 542 for sealing the inlet portion 714 and the outlet portion 715.

In detail, the head inner 53 may include an inner base 532 forming a lower surface, and an inner wall 531 extending upward along a periphery of the inner base 532.

The inlet hole 5321 and the outlet hole 5323 may be formed in the inner base 532. When the first guide protrusion 725 and the second guide protrusion 726 are inserted into the first guide hole 5231 and the second guide hole 5241, respectively, the inlet portion 714 and the outlet portion 715 may be inserted into the inlet hole 5321 and the outlet hole 5323, respectively.

Meanwhile, a filter detection device 55 for detecting mounting of the filter 60 may be provided inside the head body 52. As an example, the filter detection device 55 may be a sensor configured to detect a change in a magnetic field.

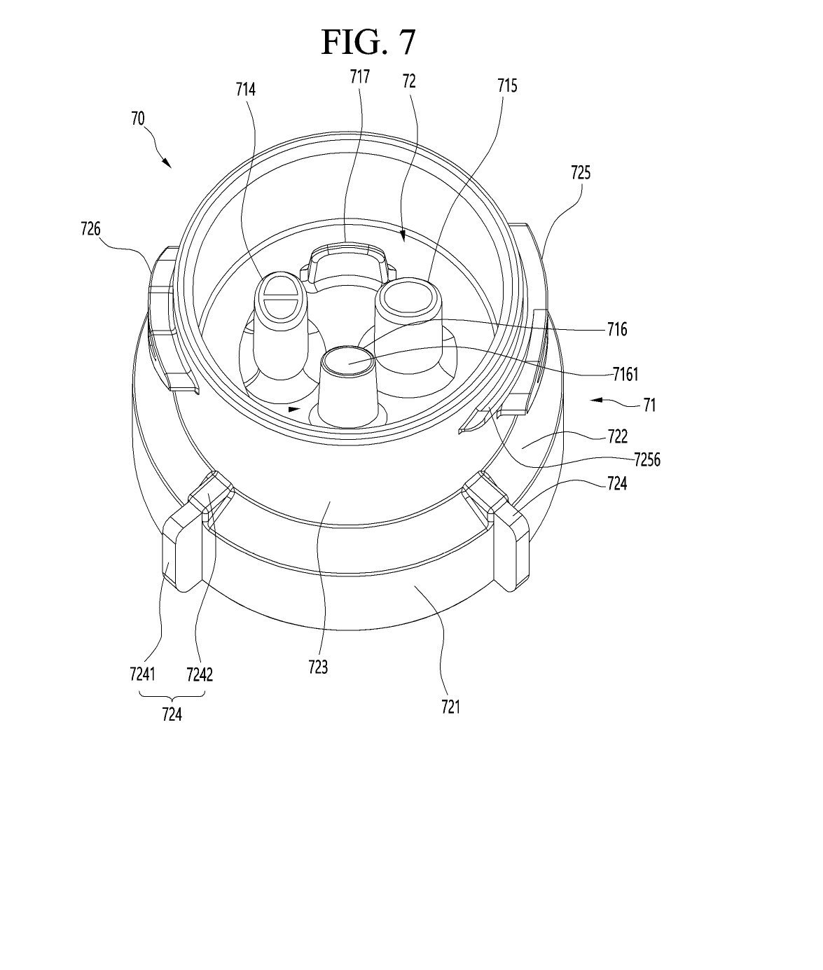

A detection hole 5237 into which a detection protrusion (716 in FIG. 7), which will be described below, is inserted may be formed in the inner base 532. Accordingly, when the detection protrusion 716 is inserted into the detection hole 5237, the filter detection device 55 may detect the detection protrusion 716 and determine whether the filter 60 is mounted.

A fixing groove 5329 into which a fixing protrusion (717 in FIG. 7) is inserted may be formed in the inner base 532. The fixing protrusion 717 may be inserted into the fixing groove 5329 so that an inner member 71 inside the adapter 70 is fixed to the head 50.

An outer surface of the inner wall 531 may be spaced apart from an inner surface of the head body 52. In this case, a thickness T1 of the first guide portion 5232 may be formed to be smaller than a thickness T2 of the second guide portion 5242. Accordingly, a gap G between an outer end of the first guide portion 5232 and the outer surface of the inner wall 531 is formed such that a protrusion extension portion (7256 in FIG. 7) of the first guide protrusion 725 can be inserted therein. On the other hand, a distance between an outer end of the second guide portion 5242 and the outer surface of the inner wall 531 has a gap narrower than a thickness of the protrusion extension portion 7256, such that insertion of the protrusion extension portion 7256 is not allowed.

That is, only the first guide protrusion 725 and the second guide protrusion 726 corresponding to the first guide 523 and the second guide 524, respectively, can be inserted. Accordingly, during mounting of the filter 60, orientations of the inlet portion 714 and the outlet portion 715 can be aligned, and thus incorrect mounting of the filter 60 can be fundamentally prevented.

Inside the head body 52, flow paths may be formed to be in fluid communication with the inlet pipe 103 and the outlet pipe 104, and with the inlet portion 714 and the outlet portion 715.

Further, a valve 56 may be provided inside the head body 52 on a flow path connected to the inlet pipe 103 and the inlet portion 714. The valve 56 may be disposed above the inlet hole 5321 and may be disposed above the inlet ring 541. The valve 56 may be opened and closed in response to coupling of the adapter 70. As an example, the valve 56 may have a check valve structure. A piston 561 configured to open and close the valve 56 may be positioned inside the inlet hole 5321. Accordingly, when the filter 60 to which the adapter 70 is coupled is mounted, the inlet portion 714 comes into contact with the piston 561, thereby enabling water to be supplied from the head 50 to the filter 60 through the adapter 70.

Hereinafter, the filter 60 will be described in detail with reference to the drawings.

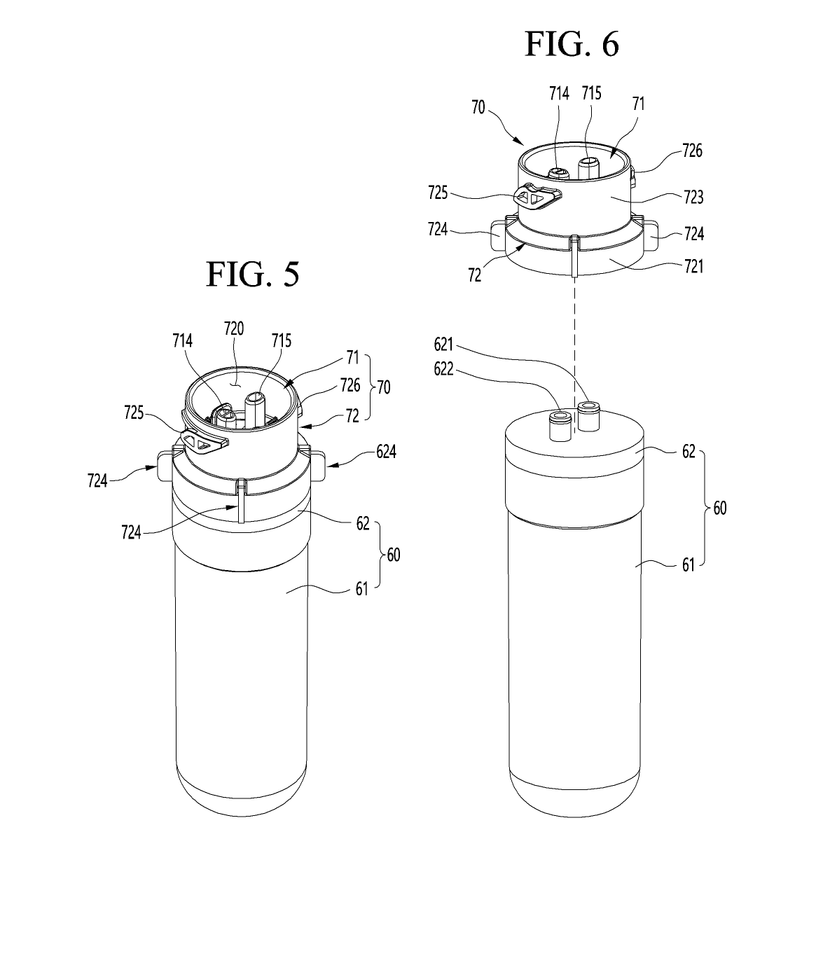

FIG. 5 is a perspective view illustrating a state in which the water filter and an adapter are coupled to each other, FIG. 6 is an exploded perspective view illustrating a state in which the water filter and the adapter are separated from each other.

As illustrated, the filter 60 may include a filter member (63 in FIG. 6) for water purification, a filter housing 61 in which the filter member 63 is accommodated, and a filter cap 62 configured to cover an open upper surface of the filter housing 61.

The filter 60 may further include the adapter 70. The adapter 70 may be supplied in a state of being mounted to an upper end of the filter 60 and may form a part of the filter 60. Alternatively, the adapter 70 may be provided independently and coupled to various filters 60 to be coupled to the head 50.

The filter housing 61 may be formed in a cylindrical shape having an open upper surface to form an outer appearance of the filter 60. Further, the filter cap 62 may be coupled to an upper end of the filter housing 61 to cover the open upper surface of the filter housing 61 and the filter member 63.

An inlet port 621 and an outlet port 622 may protrude upward from an upper surface of the filter cap 62. The inlet port 621 and the outlet port 622 may be spaced apart from each other and may be disposed on left and right sides. In addition, O-rings 6211 and 6221 may be provided around peripheries of the inlet port 621 and the outlet port 622, respectively. The inlet port 621 and the outlet port 622 may have various arrangements and shapes that are capable of being coupled to the adapter 70.

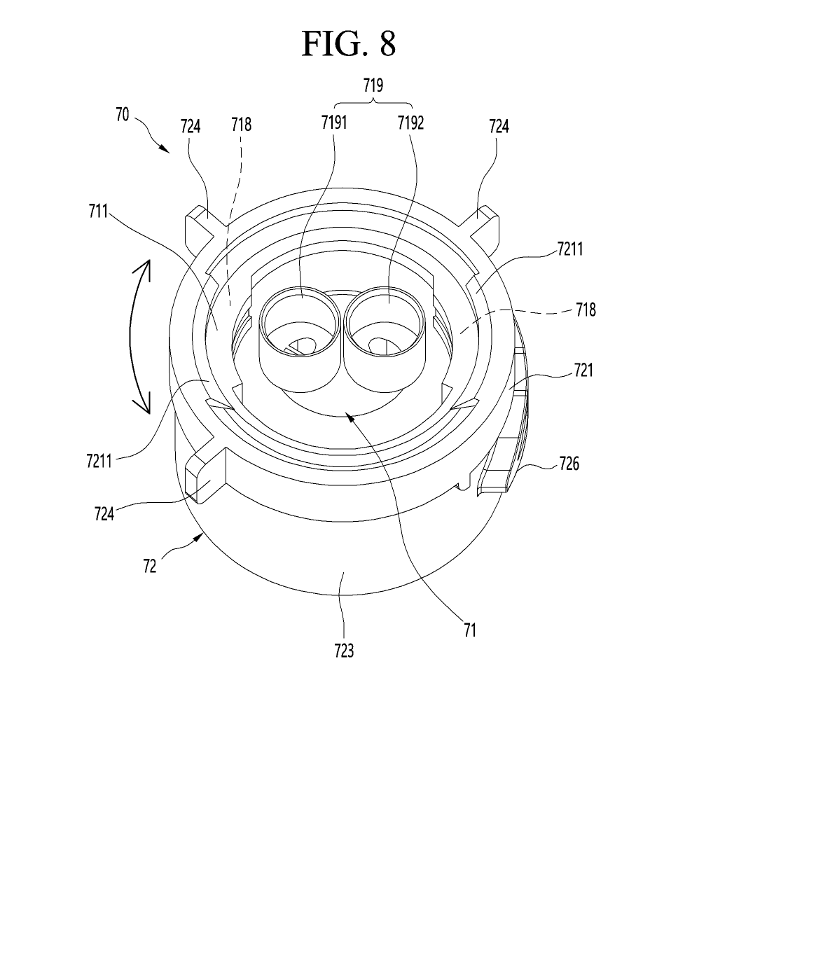

In order to couple the filter 60 to the head 50, the adapter 70 may be mounted to an upper end of the filter 60. The adapter 70 may be detachably mounted to the upper end of the filter 60, and the inlet port 621 and the outlet port 622 may be inserted into and fixed to port receiving portions 719 (see FIG. 8) opened in a lower surface of the adapter 70 without the use of a separate tool.

Meanwhile, the adapter 70 may include an outer member 72 forming an outer appearance and an inner member 71 disposed inside the outer member 72. The outer member 72 may be rotatable with respect to the inner member 71. For this purpose, an operation portion 724 for rotational operation of the outer member 72 may be provided on an outer surface of the outer member 72. In addition, the coupling portions 725 and 726 may be formed on the outer surface of the outer member 72.

A lower end of the inner member 71 may be coupled to the inlet port 621 and the outlet port 622. In addition, the inlet portion 714 and the outlet portion 715 may protrude upward from the inner member 71 to be connected to the head 50. That is, by the inner member 71, a flow path of the head 50 and an interior of the water filter 60 are in fluid communication with each other, such that water can flow and be purified.

Hereinafter, the adapter 70 will be described in more detail with reference to the drawings.

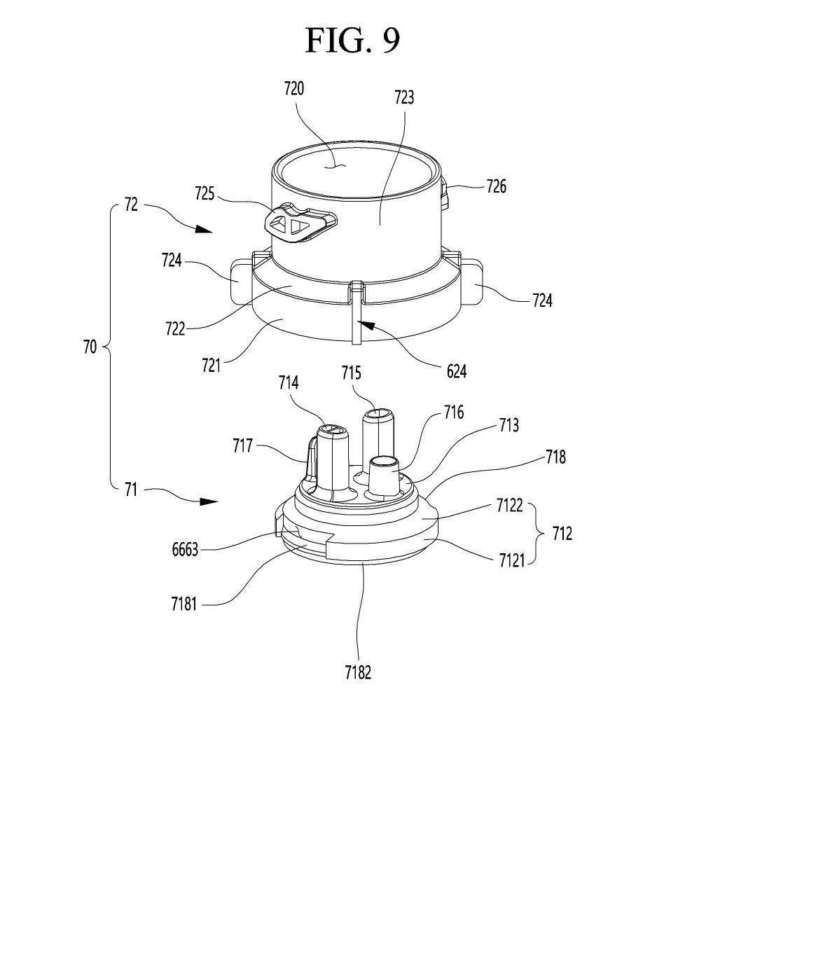

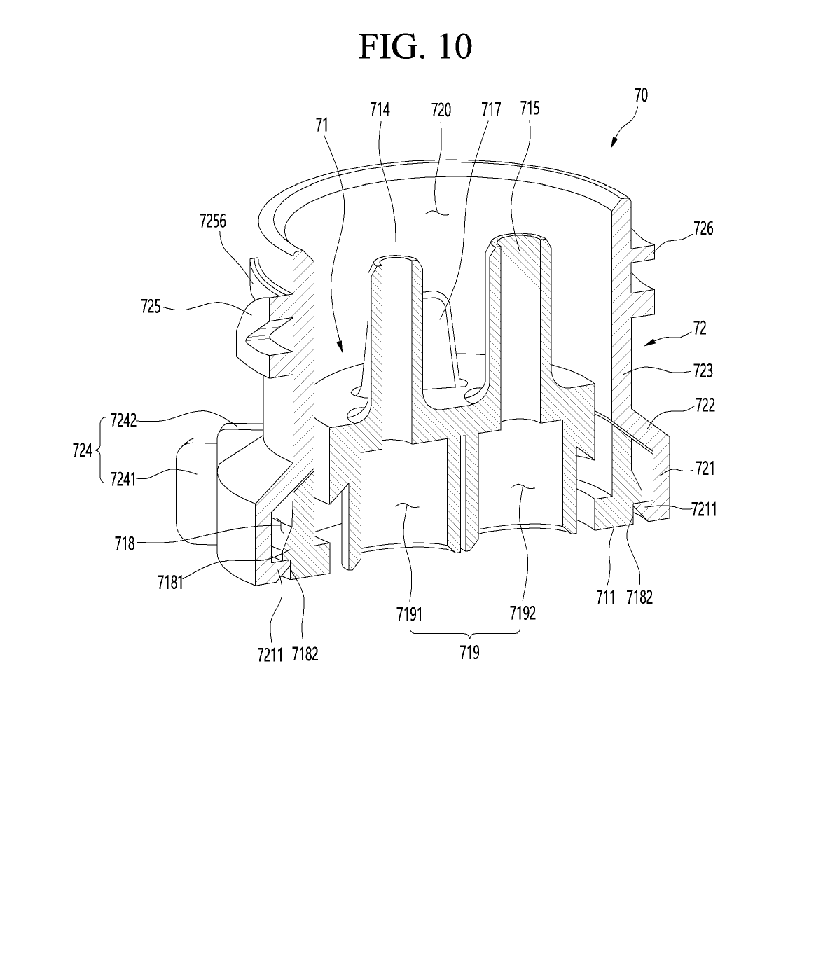

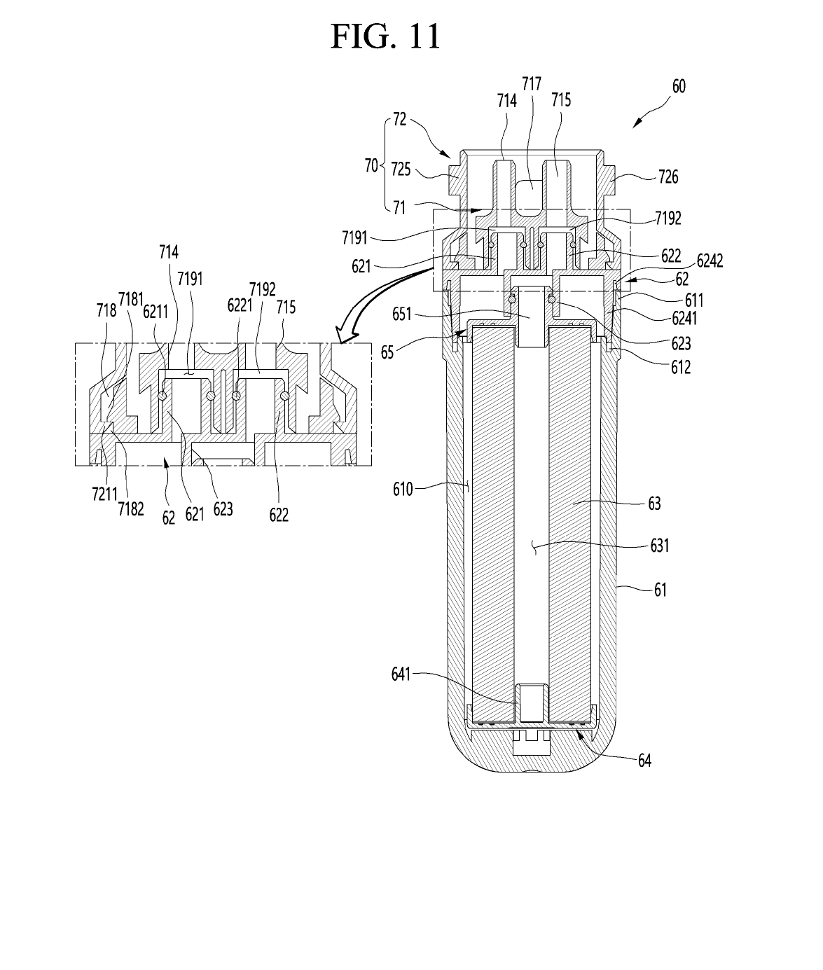

FIG. 7 is a perspective view of the adapter as viewed from above, FIG. 8 is a perspective view of the adapter as viewed from below, FIG. 9 is an exploded perspective view of the adapter, FIG. 10 is a cutaway perspective view of the adapter. FIG. 11 is a longitudinal cross-sectional view of the water filter.

As illustrated, the adapter 70 may include an outer member 72 and an inner member 71.

The outer member 72 may be formed in a cylindrical shape having an open upper surface and an open lower surface, and a hollow portion 720 may be formed therein. In addition, the outer member 72 may include a lower part 721 forming a lower portion and an upper part 723 forming an upper portion. Further, the outer member 72 may further include an extension portion 722 connecting an upper end of the lower part 721 and a lower end of the upper part 723.

The lower part 721 may have an outer diameter corresponding to an outer diameter of a lower portion of the filter housing 61 or the filter cap 62. In addition, the lower part 721 may be exposed to the outside below the head 50 and may be formed to have an outer diameter larger than an inner diameter of the head 50. Further, the lower part 721 may be formed to have a size larger than an outer diameter of the upper part 723.

An operation portion 724 may be formed on the lower part 721. The operation portion 724 may be provided in a plurality of units arranged radially with respect to a center of the outer member 72. In addition, the operation portion 724 may extend outwardly from an outer surface of the outer member 72, that is, in a direction away from the outer surface of the outer member 72.

The plurality of operation portions 624 may be disposed at respective set angles. The operation portions 624 may be exposed in a state of protruding outwardly from below the head 50. Accordingly, a rotational state of the outer member 72 can be visually recognized based on positions of the operation portions 624, and a mounting state of the filter 60 according to the rotational state of the outer member 72 can be visually identified.

The operation portion 624 may include a first part 6241 and a second part 6242. The first part 6241 may protrude outwardly from an outer surface of the lower part 721. Accordingly, a user can grip the first part 6241 to rotate the outer member 72.

The second part 6242 may form an upper portion of the operation portion 624 and may protrude upward from the extension portion 722. The second part 6242 may be positioned to face a lower periphery of the head 50. When mounting of the filter 60 is completed, the second part 6242 may be in contact with, or in very close proximity to, a lower end of the head 50. Accordingly, the user may determine a mounting state of the filter 60 based on a gap between the second part 6242 and the lower end of the head 50.

Meanwhile, a fastening hook 7211 may be provided at a lower end of the outer member 72. The fastening hook 7211 may be formed at a lower end of the lower part 721 and may protrude inwardly toward an interior of the outer member 72.

A plurality of fastening hooks 7211 may be formed along a lower end of the outer member 72, and may be formed at positions facing each other with respect to a center of the adapter 70. Ends of the fastening hooks 7211 may be fastened to rotation grooves 7182 formed in the inner member 71. When the outer member 72 is rotated, the fastening hooks 7211 may move along the rotation grooves 7182, and the outer member 72 may maintain a coupled state with the inner member 71.

The upper part 723 may be formed to be smaller than an inner diameter of the head 50. Accordingly, during mounting of the filter 60, the upper part 723 may be inserted into an interior of the head 50 through an open lower surface of the head 50. The upper part 723 may be formed to have an outer diameter smaller than an outer diameter of the lower part 721.

Coupling portions 725 and 726 may be formed on an outer surface of the upper part 723. The coupling portions 725 and 726 may be coupled to the coupling guides 523 and 524 of the head 50 during mounting of the filter 60. In addition, during rotational operation of the adapter 70, the coupling portions 725 and 726 may move axially upward along the coupling guides 523 and 524.

As an example, the coupling portions 725 and 726 may include the first guide protrusion 725 and the second guide protrusion 726. The first guide protrusion 725 and the second guide protrusion 726 may protrude outwardly from the outer surface of the upper part 723.

the first guide protrusion 725 and the second guide protrusion 726 are formed to have different shapes, thereby preventing incorrect installation of the adapter 70. For example, a protrusion extension portion 7256 that further extends along the upper part 723 may be formed at an upper end of the first guide protrusion 725.

As the outer member 72 rotates, the inlet portion 714 and the outlet portion 715 of the inner member 71 move upward and can be coupled to the head 50. Accordingly, the flow path of the head 50 and the filter 60 can be communicated with each other in a state in which water flow is enabled by the inner member 71.

The inner member 71 may have an open lower surface and may be formed in a circular shape when viewed from below. An inner rim 711 may be formed at a lower end of the inner member 71. The inner rim 711 may contact an upper surface of the filter cap 62.

The inner member 71 is provided with a rotation groove 7182. The rotation groove 7182 may be formed along the periphery of the inner rim 711. In addition, the rotation groove 7182 may be recessed at a lower end of the inner protrusion 712.

The rotation groove 7182 may be formed around an entire periphery of the inner member 71. The rotation groove 7182 may be formed to allow the fastening hook 7211 to be inserted therein, and, when the outer member 72 rotates, the fastening hook 7211 may move along the rotation groove 7182.

An inner protrusion 712 may protrude upward from the inner rim 711. The inner protrusion 712 may be formed to be stepped inward from the inner rim 711. The inner protrusion 712 may include a peripheral surface 7121 above the inner rim 711, and an inclined surface 7122 extending from an upper end of the peripheral surface 7121. The peripheral surface 7121 may contact an inner surface of the lower part 621 of the adapter 70, and the inclined surface 7122 may contact an inner surface of the extension portion 722, such that the outer member 72 can rotate stably without undesired movement.

A fastening groove 718 may be formed in the inner member 71.

The fastening groove 718 may form a path along which the fastening hook 7211 moves when the adapter 70 is mounted to the filter cap 66. The fastening groove 718 may be recessed at a position corresponding to the fastening hook 7211 and may extend in an upward-downward direction to communicate with the rotation groove 7182. Accordingly, when the adapter 70 is moved downward in a state in which the fastening hook 7211 is aligned with the fastening groove 718, the fastening hook 7211 may be inserted into the rotation groove 7182.

In addition, a restraining portion 7181 may be formed at a lower end of the fastening groove 718. The restraining portion 7181 may restrain the fastening hook 7211 that has passed through the fastening groove 718 and moved into the rotation groove 7182.

An inner upper surface 713 protruding further upward may be formed at an upper portion of the inner protrusion 712. The inner upper surface 713 may be formed to have a size corresponding to an inner diameter of the upper part 723 of the adapter 70. The inlet portion 714 and the outlet portion 715 may be formed in the inner upper surface 713.

The inlet portion 714 and the outlet portion 715 may be spaced apart from each other at positions facing each other, and may be arranged side by side between the first guide protrusion 725 and the second guide protrusion 726.

Meanwhile, when viewed from above, the inlet portion 714 and the outlet portion 715 may each be formed in an elliptical shape. In addition, when viewed from above, a major axis of a cross section of each of the inlet portion 714 and the outlet portion 715 may be oriented in different directions from each other. Accordingly, when the adapter 70 is mounted to the head 50, the inlet portion 714 and the outlet portion 715 may be coupled to the inlet hole 5321 and the outlet hole 5323 with defined orientations. That is, due to the orientation of the cross-sectional shapes of the inlet portion 714 and the outlet portion 715, incorrect installation of the filter 60 may be prevented, and accurate installation may be ensured.

In addition, a fixing protrusion 717 may protrude from the inner upper surface 713. The fixing protrusion 717 may be formed at a position corresponding to the fixing groove 5329. Further, a sensing protrusion 716 may be formed on the inner upper surface 713.

The sensing protrusion 716 may be formed to be insertable into the sensing hole 5327, and a magnet 7161 detectable by the filter sensing device 55 may be provided on an upper surface of the sensing protrusion 716.

Meanwhile, a port receiving portion 719 may be formed on a lower surface of the inner member 71. The port receiving portion 719 may be open downward from the inner member 71, and the inlet port 621 and the outlet port 622 may be inserted therein.

Specifically, the port receiving portion 719 may include an inlet port receiving portion 7191 into which the inlet port 621 is inserted, and an outlet port receiving portion 7192 into which the outlet port 622 is inserted. The inlet port receiving portion 7191 and the outlet port receiving portion 7192 may each be formed to have shapes corresponding to the inlet port 621 and the outlet port 622, respectively.

For example, the inlet port 621 and the outlet port 622 may be formed to have circular cross sections, and the inlet port receiving portion 7191 and the outlet port receiving portion 7192 may also have circular cross sections. Of course, the inlet port 621 and the outlet port 622 may have various cross-sectional shapes, such as polygonal shapes including triangular or quadrangular shapes, or elliptical shapes, and coupling with water filters having various shapes may be possible.

In a state in which the inlet port 621 and the outlet port 622 are inserted into the inlet port receiving portion 7191 and the outlet port receiving portion 7192, respectively, the O-rings 6211 and 6221 may be brought into close contact with inner wall surfaces of the inlet port receiving portion 7191 and the outlet port receiving portion 7192. The O-rings 6211 and 6221 may prevent leakage inside the inlet port receiving portion 7191 and the outlet port receiving portion 7192 and, at the same time, may allow the inlet port 621 and the outlet port 622 to be fixed in a press-fitted state within the inlet port receiving portion 7191 and the outlet port receiving portion 7192. Accordingly, the adapter 70 may maintain a firmly fixed state on the filter cap 62 even without a separate structure for restraining coupling, and arbitrary separation during use may be prevented.

Meanwhile, the inlet port receiving portion 7191 and the outlet port receiving portion 7192 may be arranged side by side and spaced apart from each other. In addition, the inner member may be coupled to and fixed with respect to the filter cap. Accordingly, relative rotation between the inner member 71 and the filter cap 62 may occur with respect to the outer member 72.

In addition, an upper end of the inlet port receiving portion 7191 may communicate with the inlet portion 714. An inner diameter of the inlet port receiving portion 7191 may be formed to be larger than an inner diameter of the inlet portion 714. Further, an upper end of the outlet port receiving portion 7192 may communicate with the outlet portion 715. An inner diameter of the outlet port receiving portion 7192 may be formed to be larger than an inner diameter of the outlet portion 715. Accordingly, the inner member 71 and the filter cap 62 may be stably and firmly coupled to each other.

Meanwhile, the filter housing 61 and the filter cap 62 may be coupled to each other by adhesion or thermal fusion. For example, a cap coupling groove 6242 configured to receive a housing coupling portion 611 at an upper end of the filter housing 61 may be formed along a periphery of the filter cap 62. In addition, a cap coupling portion 6241 extending downward may be formed along the periphery of the filter cap 62. Further, a housing coupling groove 612 configured to receive an end of the cap coupling portion 6241 may be formed on an inner surface of the filter housing 61. In addition, an outer surface of the cap coupling portion 6241 may be coupled in contact with the inner surface of the filter housing 61.

The filter member 63 may be formed in a cylindrical shape having a hollow 631 penetrating through a center thereof. The filter member 63 may be formed of a porous material so as to purify water passing through the filter member 63.

A lower supporter 64 may be provided on a lower surface of the filter member 63. The lower supporter 64 may support the filter 60 from below. A lower boss 641 configured to be inserted into the hollow 631 may be provided at a center of the lower supporter 64.

An upper supporter 65 may be provided on an upper surface of the filter member 63. The upper supporter 65 may include an upper boss 651 extending in an upward-downward direction at a center thereof. A lower portion of the upper boss 651 may be inserted into the hollow 631. In addition, an upper portion of the upper boss 651 may be inserted into a nipple receiving portion 623 at a center of the filter cap 62.

Hereinafter, a water flow state of the filter assembly 40 in a state in which the filter 60 is coupled will be described in more detail with reference to the drawings.

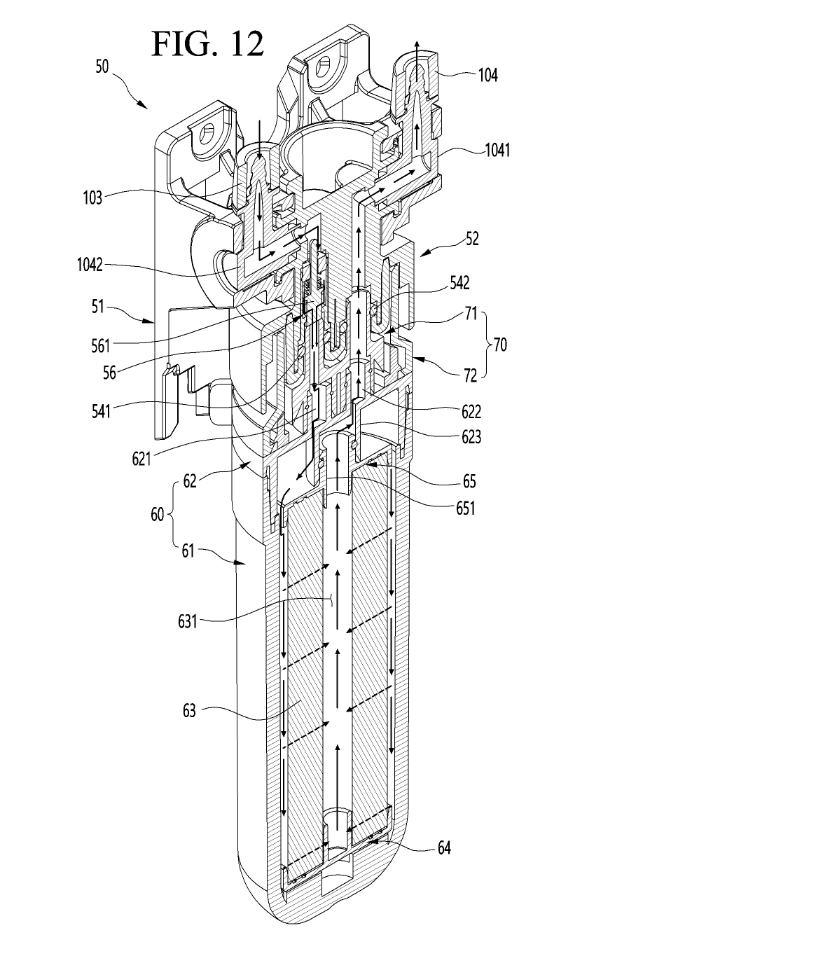

FIG. 12 is a cutaway perspective view illustrating a flow of water in a state in which the water filter is mounted.

As illustrated, in a state in which the adapter 70 is coupled to an upper end of the filter 60, the filter 60 may be mounted to the head 50.

At this time, the inlet port 621 may be inserted into an interior of the inlet port receiving portion 7191, and the outlet port 622 may be in a state of being inserted into the outlet port receiving portion 7192. In addition, the inlet portion 714 and the outlet portion 715 may be inserted into the inlet hole 5321 and the outlet hole 5323, respectively. Accordingly, the head 50 and the filter 60 may be in a state in which water flow passages are connected by the adapter 70.

An upper end of the inlet portion 714 may contact the piston 561 to open the valve 56. Water supplied to the head 50 by opening of the water supply valve 102 may pass through the valve 56 and flow into the inlet portion 714, and may be supplied into the interior of the filter 60 via the inlet portion 714.

In addition, water introduced into the interior of the filter 60 may flow downward from the filter cap 62 and be guided to an outside of the filter member 63. Further, water outside the filter member 63 may pass through the filter member 63 and move into the hollow of the filter member 63. At this time, the water may be purified while passing through the filter member 63. The purified water may move upward through the hollow 631 and may be discharged to the outside of the filter 60 by sequentially passing through the upper boss 651, the nipple receiving portion 623, and the outlet port 622.

In addition, the purified water from the filter 60 may sequentially pass through the outlet port 622 and the outlet portion 715, flow into the interior of the head 50, and be discharged to the outside through the outlet pipe 104. Further, the water flowing along the outlet pipe 104 may be supplied to the water device.

After purifying water for a preset period or a preset amount of water, the filter 60 may be separated from the head 50 and replaced with a new filter 60. To separate the filter 60 from the head 50, when the adapter 70 is rotationally operated, the filter housing 61 and the filter cap 66 may move downward. At this time, due to the rotation of the adapter 70, the inlet portion 714 and the outlet portion 715 may move downward and be withdrawn from the inlet hole 5321 and the outlet hole 5323. In addition, the valve 56 may return to a closed state due to the downward movement and separation of the inlet portion 714, thereby preventing water introduced through the inlet pipe 103 from leaking to the outside of the head 50.

In addition, for replacement of the filter 60, the adapter 70 may be separated from the filter cap 62. Further, the adapter 70 may be mounted to a new filter 60 and then coupled to the head 50 again.

Hereinafter, a mounting process of the filter 60 having the above-described structure will be described in more detail with reference to the drawings.

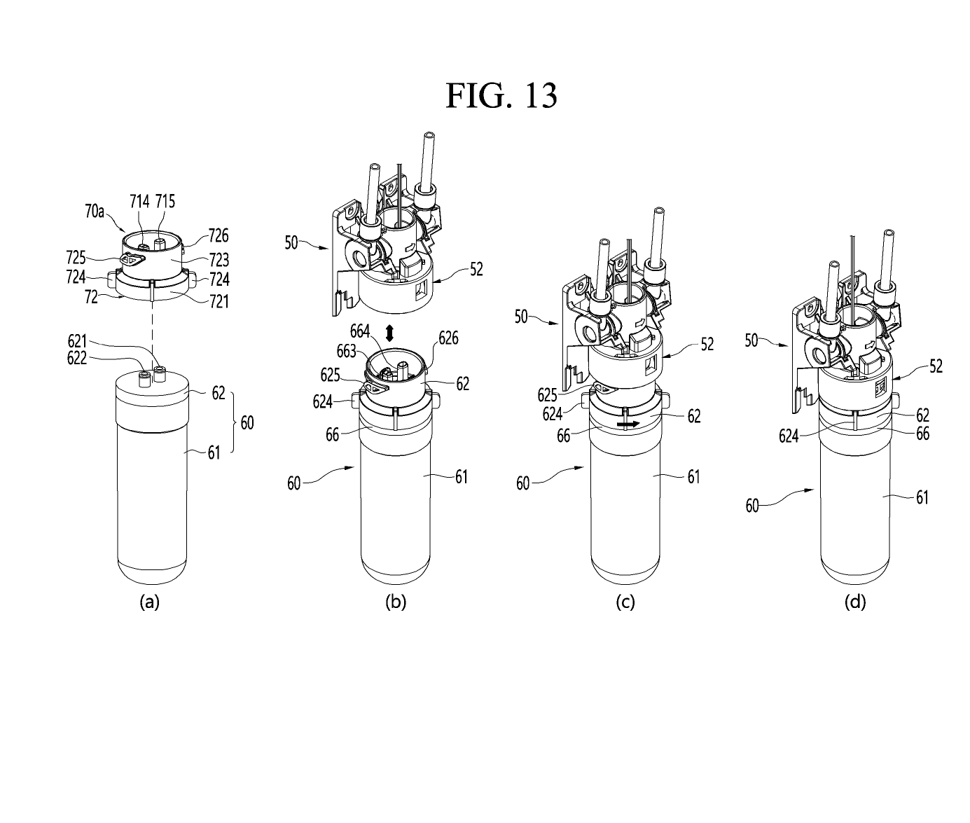

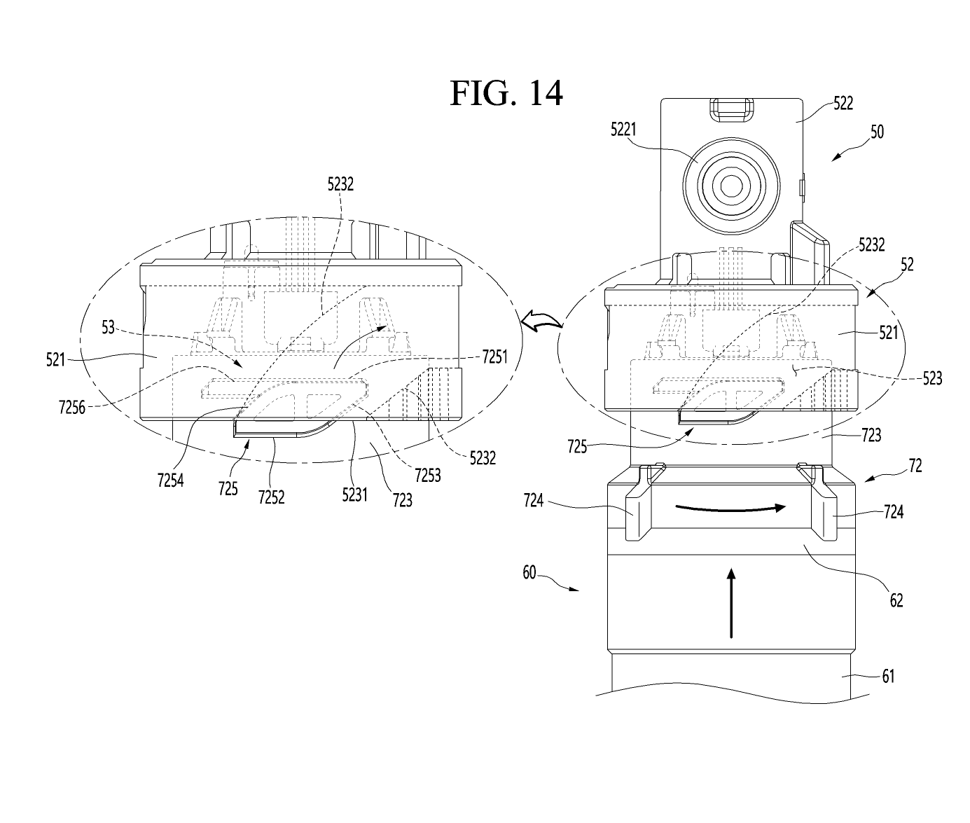

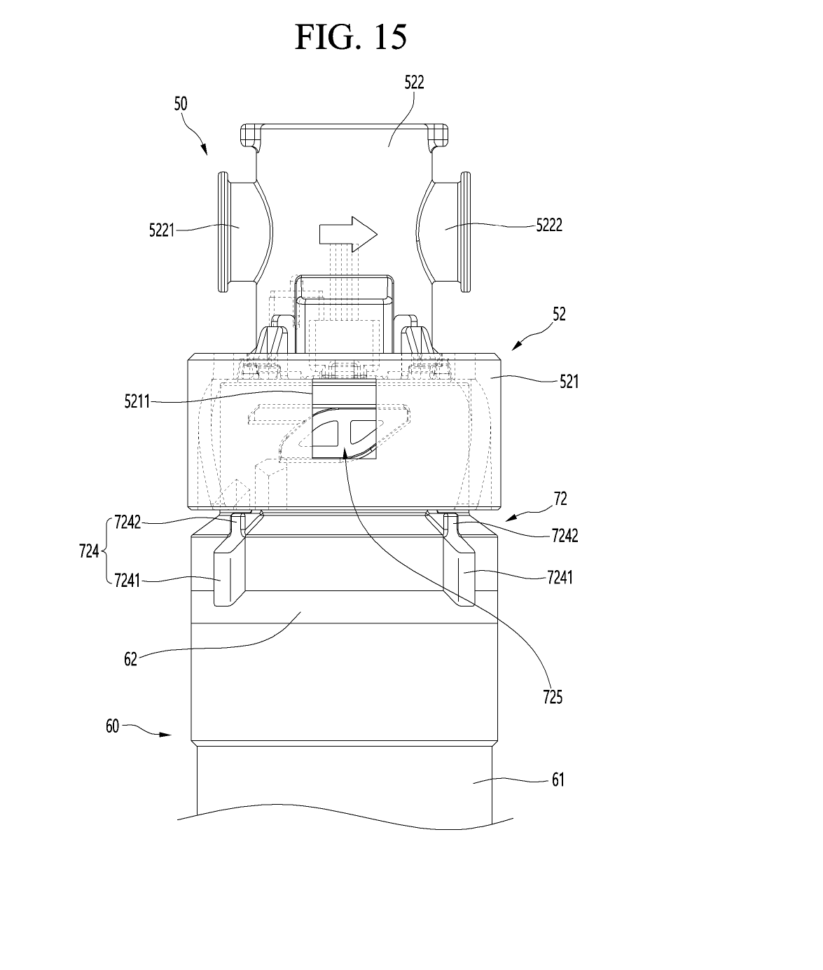

FIG. 13 is a view illustrating a process of mounting the water filter in a step-by-step manner, FIG. 14 is a view illustrating a state of the adapter inside the head when the adapter is rotated, FIG. 15 is a view illustrating a state of the adapter inside the head when mounting of the water filter is completed.

As illustrated, in order to mount the filter 60 to the head 50, the adapter 70 is coupled to the filter 60. By coupling of the adapter 70, the inlet port 621 and the outlet port 622 may be connected to the adapter 70. In addition, as shown in (a) of FIG. 13, the adapter 70 may be in a state of being coupled to an upper end of the filter cap 62. Accordingly, the adapter 70 may be arranged such that an upper surface thereof faces upward, and the inlet portion 714 and the outlet portion 715 inside the adapter 70 may be exposed upward.

In addition, in a state in which the adapter 70 is mounted, the filter 60 is disposed below the head 50. At this time, the inlet portion 714 and the outlet portion 715 of the adapter 70 may be in an aligned state so as to be inserted into the inlet hole 5321 and the outlet hole 5323. Further, as shown in (b) of FIG. 13, the coupling portions 725 and 726 of the adapter 70 may also be aligned with the coupling guides 523 and 524, such that the adapter 70 may be in an aligned state.

That is, the adapter 70 is aligned such that the first guide protrusion 725, the second guide protrusion 726, the inlet portion 714, and the outlet portion 715 are aligned on the same extension line, and then the filter 60 to which the adapter 70 is mounted is positioned below the head 50.

n a state in which the adapter 70 is aligned, the filter 60 to which the adapter 70 is mounted may be moved upward, and an upper end of the adapter 70 may be inserted into the head 50. As shown in (c) of FIG. 13, the coupling portions 725 and 726 may be inserted through open lower surfaces of the coupling guides 523 and 524, and the upper end of the adapter 70 may be inserted into the interior of the head 50.

In this state, by rotationally operating the outer part 72 of the adapter 70 to move the filter 60 to which the adapter 70 is mounted upward, connection between the filter 60 and the head 50 may be performed.

Specifically, as shown in FIG. 14, the user may insert the first guide protrusion 725 and the second guide protrusion 726 into the first guide hole 5231 and the second guide hole 5241, respectively, which are opened in a lower surface of the head body 52.

In a state in which the first guide protrusion 725 and the second guide protrusion 726 are inserted into the first guide and the second guide 524, the user may rotate the outer member 72 in a forward direction (counterclockwise when viewed in FIG. 14).

As the outer member 72 rotates in the forward direction, the first guide protrusion 725 and the second guide protrusion 726 move along the first guide portion 5232 and the second guide portion 5242 within the first guide and the second guide 524. As the first guide protrusion 725 and the second guide protrusion 726 move along the first guide 523 and the second guide 524, the filter housing 61 and the filter cap 66 may be moved upward.

For example, the first guide protrusion 725 may include a first upper portion 7251, a first lower portion 7252, and a first front inclined portion 7253 and a first rear inclined portion 7254 connecting both ends of the first upper portion 7251 and the first lower portion 7252. The first front inclined portion 7253 and the first rear inclined portion 7254 may protrude so as to move in a contact state with the first guide portion 5232.

In addition, the second guide protrusion 726 may include a second upper portion 7261, a second lower portion 7262, and a second front inclined portion 7263 and a second rear inclined portion 7264 connecting both ends of the second upper portion 7261 and the second lower portion 7262. Further, the second front inclined portion 7263 and the second rear inclined portion 7264 may protrude so as to move in a contact state with the second guide portion 5242.

In addition, the inlet portion 714 and the outlet portion 715 may be inserted into the corresponding inlet hole 5321 and outlet hole 5323, respectively. Further, the fixing protrusion 717 and the sensing protrusion 716 may also be inserted into the fixing groove 5329 and the sensing hole 5237, respectively.

That is, by rotationally operating only the outer member 72 of the adapter 70, the aligned inner member 71, the filter housing 61, and the filter cap 66 may move upward without rotating, and insertion of the inlet portion 714 and the outlet portion 715 may be automatically performed.

As rotation of the outer member 70 proceeds, the inlet portion 714 and the outlet portion 715 may further move upward by passing through the inlet ring 541 and the outlet ring 542, respectively. Accordingly, the inlet portion 714 and the outlet portion 715 may be brought into an airtight state within the inlet hole 5321 and the outlet hole 5323.

As shown in (d) of FIG. 13, when the adapter 70 is rotated by a preset angle, the filter housing 61 and the filter cap 66 may be moved upward to a maximum extent, and insertion of the inlet portion 714 and the outlet portion 715 may be completed.

When the outer member 72 is rotated in the forward direction by the preset angle, the first guide protrusion 725 and the second guide protrusion 726 may move to upper ends of the first guide 523 and the second guide 524. In addition, an end of the inlet portion 714 may be in a maximally inserted state within the inlet hole 5321 and the outlet hole 5323, and may contact the valve 56 to open the valve 56.

In addition, the fixing protrusion 717 and the sensing protrusion 716 may also be further inserted into the fixing groove 5329 and the sensing hole 5237, respectively. When the sensing protrusion 716 is fully inserted into the sensing hole 5237, the filter sensing device 55 may detect this and open the water supply valve 102, whereby water supply to the filter 60 is initiated.

Specifically, as shown in FIG. 15, in a state in which the adapter 70 is completely coupled to the head body 52, the first guide protrusion 725 and the second guide protrusion 726 may move laterally at upper ends of the first guide 523 and the second guide 524 and maintain a fixed state.

At this time, the first guide protrusion 725 may be positioned within the inspection window 5211. The inspection window 5211 may be open forward, and the first guide protrusion 725 may be exposed forward through the inspection window 5211. Accordingly, the user may visually confirm that the connection rib 6255 is positioned at a center of the inspection window 5211, thereby visually confirming that mounting of the adapter 70 to the head 50 has been completed.

In addition, a rotation amount of the adapter 70 may be recognized through a rotational position of the operation portion 624, and completion of mounting of the filter 60 to the head 50 may also be visually confirmed. Further, since an upper end of the operation portion 624 comes into contact with a lower end of the head 50, completion of mounting of the adapter 70 to the head 50 may also be visually confirmed.

When insertion of the inlet portion 714 and the outlet portion 715 into the inlet hole 5321 and the outlet hole 5323 is completed, flow paths inside the filter 60 and inside the head 50 may be communicated with each other by the adapter 70. In addition, the valve 56 and the water supply valve 102 may be opened to supply water to the filter 60, and purified water from the filter 60 may be supplied to the water device.

Meanwhile, when the filter 60 is used for a preset period of time or a preset amount of water, performance thereof may deteriorate, and replacement may be required. To replace the filter 60, the adapter 70 may first be separated from the head 50 in a reverse order of the above-described process.

That is, when the adapter 70 is rotated in a reverse direction while the filter 60 is coupled to the head, the filter cap 66 and the filter housing 61 may move downward without rotating. In addition, the inlet portion 714 and the outlet portion 715 may be withdrawn from the inlet hole 5321 and the outlet hole 5323. At this time, the valve 56 is closed, thereby preventing leakage during the separation process of the filter 60.

In addition, after the adapter 70 is completely separated from the head 50, the adapter 70 may be separated from the filter 60 and then mounted again to a new filter 60.

Meanwhile, in addition to the above-described embodiment, various other embodiments of the present invention may be possible. Hereinafter, other embodiments of the present invention will be described with reference to the drawings. Among components of the other embodiments of the present invention, components identical to those of the above-described embodiment may have detailed descriptions and illustrations thereof omitted, and may be described using the same reference numerals. That is, hereinafter, only structures different from those of the above-described embodiment will be described, and other components not described may be the same as those of the above-described embodiment. Accordingly, components that are not illustrated or not described in detail may be referred to from the drawings of the above-described embodiments.

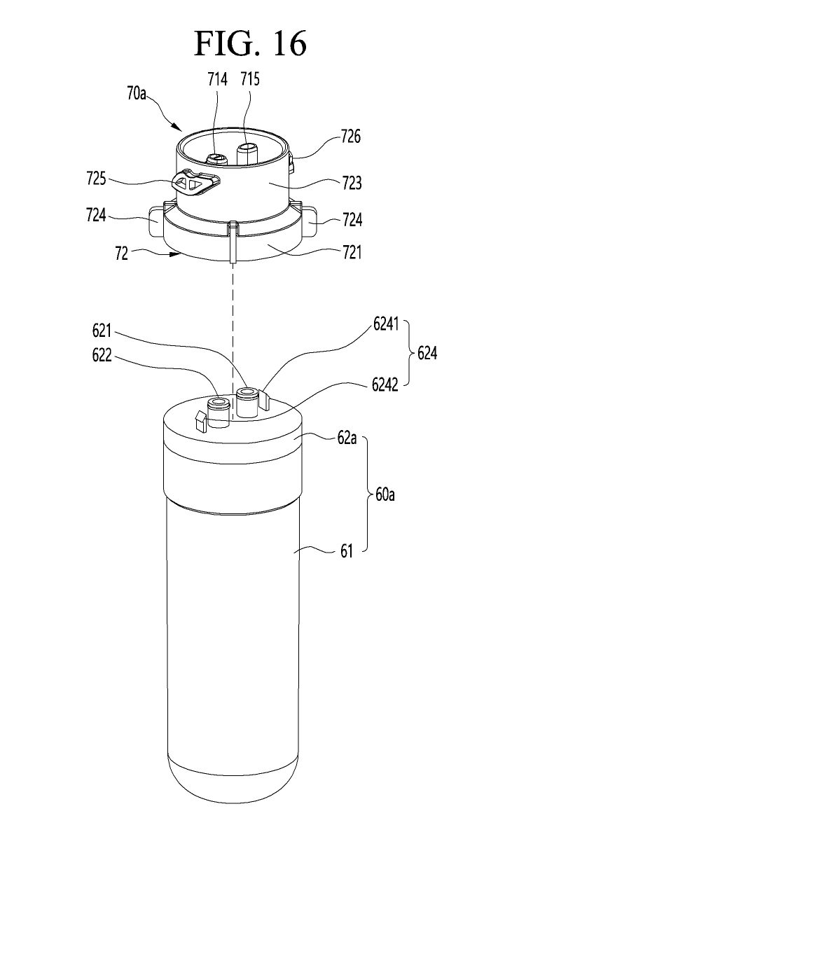

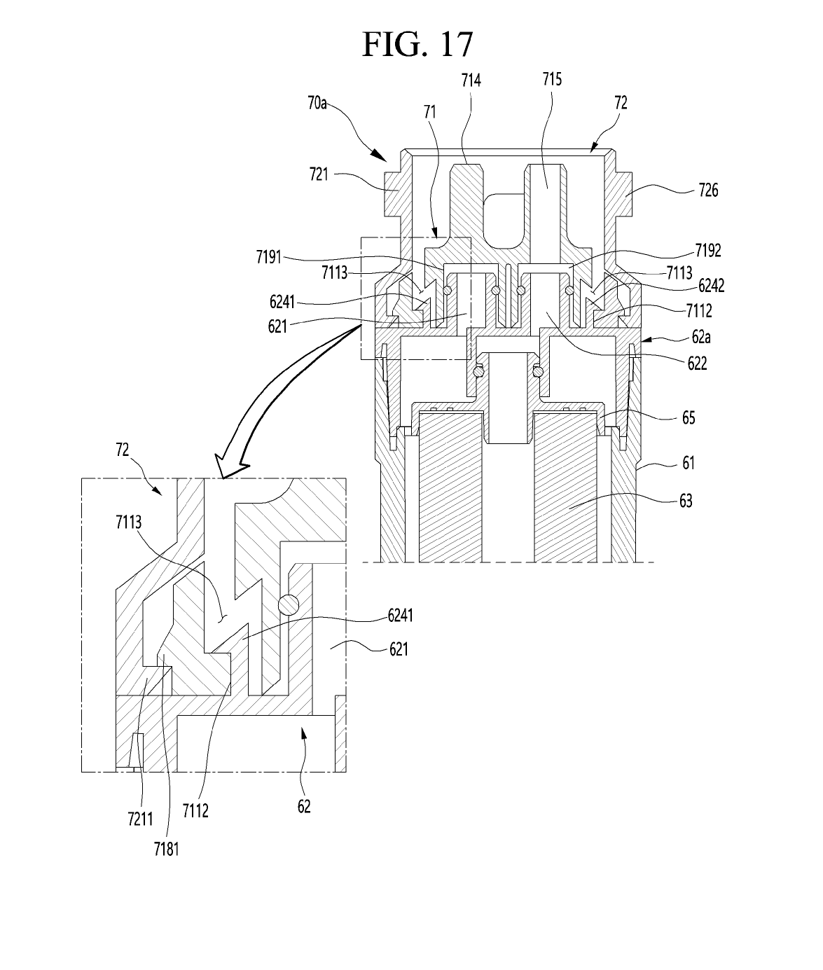

FIG. 16 is an exploded perspective view illustrating a state in which a water filter and an adapter according to another embodiment of the present invention are separated from each other, FIG. 17 is a partial cross-sectional view illustrating a coupling structure between the water filter and the adapter.

As illustrated, a filter 60a according to another embodiment of the present invention may have an exterior formed by a filter housing 61 and a filter cap 62a. In addition, an adapter 70a may be provided at an upper end of the filter cap 62a.

The inlet port 621 and the outlet port 622 may be provided on an upper surface of the filter cap 62a. In addition, a filter coupling portion 624 may be formed on the upper surface of the filter cap 62a. The filter coupling portion 624 may be formed in a hook shape, and may be hooked and restrained to one side of the adapter 70a when the adapter 70a is mounted to the filter cap 62a. For example, the filter coupling portion 624 may be formed in a hook shape. Further, the filter coupling portion 624 may be integrally formed during molding of the filter cap 62a.

The filter coupling portion 624 may include a first filter coupling portion 6241 and a second filter coupling portion 6242. The first filter coupling portion 6241 and the second filter coupling portion 6242 may be provided at positions facing each other with respect to a center of the filter cap 62a. In addition, the pair of filter coupling portions 624 may be arranged on the same extension line as the inlet port 621 and the outlet port 622. Accordingly, when the adapter 70a is coupled to the filter cap 62a, the filter coupling portions 624 and the port receiving portion 719 may be aligned and mounted at the same time.

The adapter 70a may include an outer member 72 and an inner member 71. In addition, the outer member 72 may be composed of a lower part 721 and an upper part 723. Further, an operation portion 724 may be formed on an outer surface of the lower part 721. In addition, coupling portions 725 and 726 may be formed on an outer surface of the upper part 723.

The inner member 71 may be provided inside the outer member 72 and may be exposed through an open upper surface and an open lower surface of the outer member 72. In addition, a fastening hook 7211 at a lower end of the outer member 72 may be inserted into the rotation groove 7182 at a lower end of the inner member 71. Accordingly, the outer member 72 may rotate with respect to the inner member 71 in a state in which the outer member 72 is coupled to the inner member 71.

An inlet portion 714 and an outlet portion 715 protruding upward may be formed on an upper surface of the inner member 71. In addition, an inlet port receiving portion 7191 and an outlet port receiving portion 7192 may be open downward on a lower surface of the inner member 71. When the adapter 70a is mounted to the filter cap 62a, the inlet port 621 and the outlet port 622 may be inserted into the inlet port receiving portion 7191 and the outlet port receiving portion 7192.

Meanwhile, a coupling hole 7112 into which the filter coupling portion 624 is inserted may be formed on a lower surface of the inner member 71. In addition, a locking portion 7113 may be formed inside the coupling hole 7112 so that the hook-shaped filter coupling portion 624 is locked and restrained. When the filter coupling portion 624 is inserted into the coupling hole 7112, the adapter 70a may be firmly fixed to the filter cap 62a. Of course, instead of a hook shape, the filter coupling portion 624 may have other structures capable of coupling the adapter 70a and the filter cap 62a to each other.

In addition, the adapter 70a may be fixed to the filter cap 62a without a separate tool, and, in a process of inserting the inlet port 621 and the outlet port 622 into the inlet port receiving portion 7191 and the outlet port receiving portion 7192, the filter coupling portion 624 may be inserted into the coupling hole 7112.

In a state in which the adapter 70a is mounted to the filter cap 62a, the adapter 70a may be rotationally coupled to the head 50 so that a flow path of the head 50 and a flow path of the filter 60a are connected to each other, thereby enabling a water-purifiable state using the filter 60a.

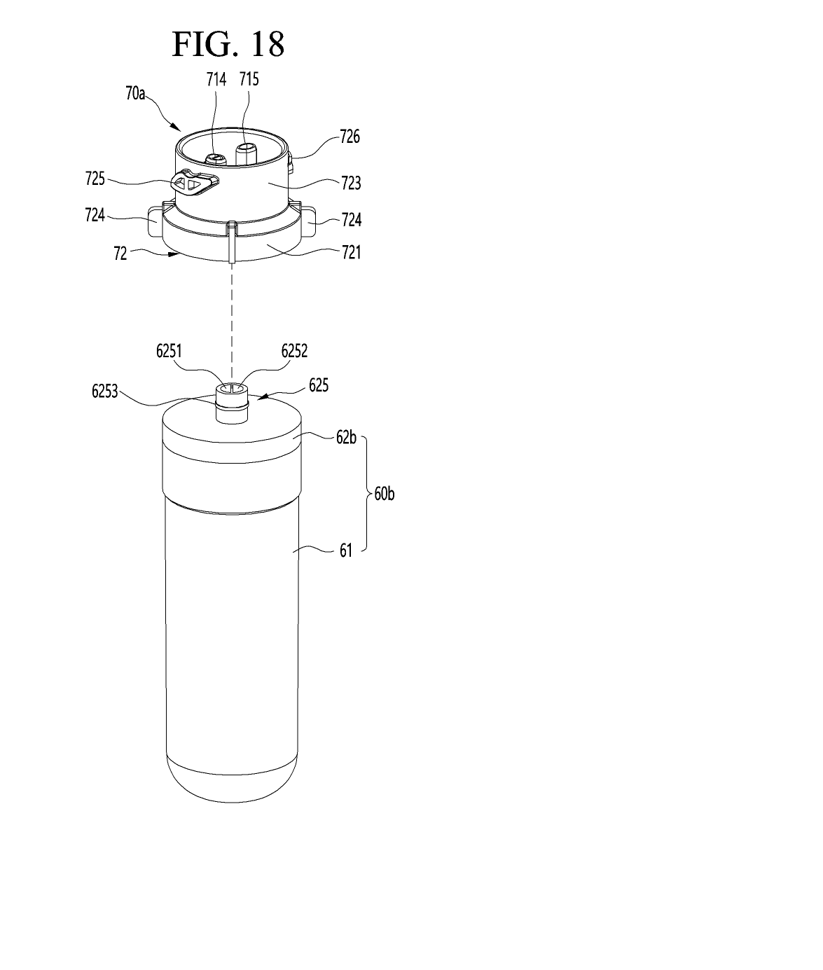

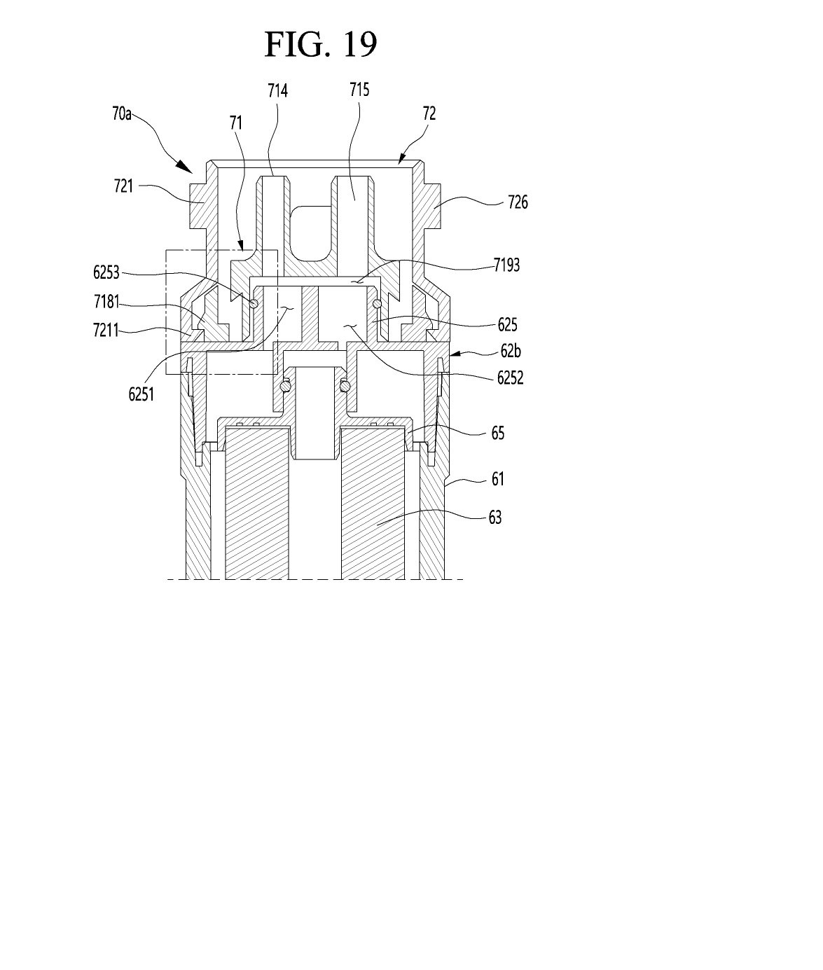

FIG. 18 is an exploded perspective view illustrating a state in which a water filter and an adapter according to still another embodiment of the present invention are separated from each other, FIG. 19 is a partial cross-sectional view illustrating a coupling structure between the water filter and the adapter.

As illustrated, a filter 60b according to yet another embodiment of the present invention may have an exterior formed by a filter housing 61 and a filter cap 62b. In addition, an adapter 70b may be provided at an upper end of the filter cap 62b.

A port portion 625 through which water is introduced and discharged may be formed on an upper surface of the filter cap 62b. The port portion 625 may be formed in a single protruding shape, and an interior of the port portion 625 may be partitioned into an inlet port 6251 and an outlet port 6252. That is, an inlet flow path and an outlet flow path may be separately partitioned and formed inside one protruding port portion 625.

In addition, an O-ring may be formed around the port portion 625, such that, when the adapter 70b is coupled to the filter cap 62b, the O-ring may be pressed into close contact with an inner surface of the port receiving portion 7193 of the adapter 70b.

In addition, an O-ring may be formed around the port portion 625, such that, when the adapter 70b is coupled to the filter cap 62b, the O-ring may be pressed into close contact with an inner surface of the port receiving portion 7193 of the adapter 70b.

The inner member 71 may be provided inside the outer member 72 and may be exposed through an open upper surface and an open lower surface of the outer member 72. In addition, a fastening hook 7211 at a lower end of the outer member 72 may be inserted into the rotation groove 7182 at a lower end of the inner member 71. Accordingly, the outer member 72 may rotate with respect to the inner member 71 in a state in which the outer member 72 is coupled to the inner member 71.

An inlet portion 714 and an outlet portion 715 protruding upward may be formed on an upper surface of the inner member 71. In addition, a port receiving portion 7193 may be open downward on a lower surface of the inner member 71.

The port receiving portion 7193 may be formed at a center of a lower surface of the inner member 71 and may be formed to receive the port portion 625. In addition, an upper surface of the port receiving portion 7193 may communicate with lower ends of the inlet portion 714 and the outlet portion 715.

When the adapter 70b is mounted to the filter cap 62b, the port portion 625 may be inserted into the port receiving portion 7193. In addition, an upper end of the port portion 625 may be brought into close contact with an upper surface of the port receiving portion 7193. Further, the inlet port 6251 and the outlet port 6252 inside the port receiving portion 7193 may be positioned at positions corresponding to the inlet portion 714 and the outlet portion 715, respectively, so as to communicate with each other.

Accordingly, water flowing into the inlet portion 714 may be introduced into the interior of the filter 60b through the inlet port 6251, and purified water inside the filter 60b may be discharged through the outlet port 6252 to the outlet portion 715.

In addition, the adapter 70b may be fixed to the filter cap 62b without a separate tool, and, when the port portion 625 is inserted into the port receiving portion 7193, the adapter 70b may be fixed to the filter cap 62b by pressurized close contact of the O-ring 6253.

In a state in which the adapter 70b is mounted to the filter cap 62b, the adapter 70b may be rotationally coupled to the head 50 so that a flow path of the head 50 and a flow path of the filter 60b are connected to each other, thereby enabling a water-purifiable state using the filter 60b.

Meanwhile, the filter 60b according to an embodiment of the present invention may be configured with port portions 625 having various shapes, and the adapter 70b may be configured with port receiving portions 7193 having various shapes into which the port portion 625 can be inserted, thereby being applicable to filters 60b having various structures.

A water filter according to a proposed embodiment, a home appliance including the water filter, and a method of mounting the water filter provide the following advantages.

According to an embodiment of the present invention, the water filter may be mounted to the head by connecting an adapter. Accordingly, it is possible to mount water filters having various structures, which are connectable to the adapter, to the head.

In particular, even when the water filter has a structure that is not directly coupled to the head, the water filter can be mounted to the head by connecting the adapter, thereby making it possible to use various water filters.

Further, by coupling the adapter to the water filter, when the adapter is rotatably coupled to the head, the head and the water filter can be connected to each other so that water is allowed to flow therebetween.

In this case, an inlet portion and an outlet portion of the adapter are not rotated, and the adapter may have a structure in which the adapter is coupled to the head by moving upward or separated from the head by moving downward when a rotational operation of an outer member of the adapter is performed.

Accordingly, since the inlet portion and the outlet portion of the adapter, which are directly connected to a flow path of the head, have minimized axial movement, there is an advantage in that leakage can be prevented during a process of connecting the filter.

What is claimed is:

1. A water filter detachably coupled to a head connected to a water supply source, the water filter comprising:
a filter housing accommodating a filter member for water purification;
a filter cap covering an open upper surface of the filter housing and provided with an inlet port and an outlet port; and
an adapter coupled to the filter cap,
wherein the adapter, in a state of being coupled to the filter cap, is rotatably coupled to the head so as to place the inlet port and the outlet port in communication with a flow path inside the head.

2. The water filter according to claim 1,
wherein the adapter includes:
an outer member forming an outer surface, the outer member having an open upper surface and an open lower surface and defining a hollow space; and
an inner member disposed in the hollow and coupled to the inlet port and the outlet port,
wherein the outer member is rotatably coupled to the head by rotating with respect to the inner member, and
wherein, during rotational coupling of the outer member, the inner member moves upward in a non-rotating state.

3. The water filter according to claim 2,
wherein the outer member includes:
an upper part inserted into an interior of the head and rotatably coupled to the head; and
a lower part extending downward from a lower end of the upper part, the lower part being exposed below the head and configured to be rotationally operated by a user.

4. The water filter according to claim 3,
wherein an outer diameter of the lower part is formed to be larger than an outer diameter of the inner member.

5. The water filter according to claim 3,
wherein the upper part has, on an outer surface of the upper par, a coupling portion protruding outward and rotatably coupled to the head, and
wherein, as the outer member rotates, the coupling portion moves upward along the head.

6. The water filter according to claim 3,
wherein a plurality of operation portions operated to rotate the outer member are provided on an outer surface of the lower part.

7. The water filter according to claim 6,
wherein each of the operation portions includes:
a first part protruding in a circumferential direction from an outer surface of the lower part; and
a second part protruding upward from the lower part.

8. The water filter according to claim 2,
wherein the outer member is provided with a fastening hook protruding inward,
wherein the inner member is formed with a rotation groove into which the fastening hook is inserted, and
wherein the rotation groove is formed along a periphery of the inner member so as to guide movement of the fastening hook during rotation of the outer member.

9. The water filter according to claim 8,
wherein a fastening groove extending to communicate with the rotation groove is formed on an outer surface of the inner member, and
wherein the fastening groove is formed to have a size corresponding to the fastening hook so as to guide the fastening hook to move into the rotation groove.

10. The water filter according to claim 1,
wherein the inner member is provided inside the outer member, and
wherein an upper end and a lower end of the inner member are positioned between an upper end and a lower end of the outer member.

11. The water filter according to claim 1,
wherein the inner member includes:
a port receiving portion opened downward and into which the inlet port and the outlet port are inserted; and
an inlet portion and an outlet portion protruding upward from an upper surface of the inner member and inserted into the head,
wherein the inlet portion and the outlet portion communicate with the port receiving portion.

12. The water filter according to claim 11,
wherein O-rings are provided on outer surfaces of the inlet port and the outlet port, and
wherein the O-rings are press-fitted against inner surfaces of the port receiving portion to maintain a state in which the adapter is coupled to the filter cap.

13. The water filter according to claim 11,
wherein a filter coupling portion protruding upward is formed on an upper surface of the filter cap,
wherein a coupling hole into which the filter coupling portion is inserted is formed in a lower surface of the inner member, and
wherein, by coupling of the filter coupling portion and the coupling hole, the inner member is maintained in a state of being coupled to the filter cap.

14. The water filter according to claim 11,
wherein the inlet port and the outlet port are in contact with each other to form a single port portion and are inserted into the port receiving portion, and
wherein the inlet portion and the outlet portion branch from the single port receiving portion.

15. The water filter according to claim 11,
wherein the port receiving portion includes an inlet port receiving portion into which the inlet port is inserted and an outlet port receiving portion into which the outlet port is inserted, and
wherein the inlet portion communicates with an upper surface of the inlet port receiving portion and the outlet portion communicates with the outlet port receiving portion.

16. An adapter for a water filter, comprising:
an outer member having an open upper surface and an open lower surface and defining a hollow space, the outer member being rotatably coupled to a head of a household appliance; and
an inner member disposed inside the hollow and connected to an inlet port and an outlet port of the water filter,
wherein the outer member rotates with respect to the inner member, and
wherein, during rotational coupling of the outer member, the inner member moves upward and downward to connect the inlet port and the outlet port to a flow path of the head.

17. The adapter for a water filter according to claim 16,
wherein the outer member is provided with a fastening hook protruding inward,
wherein the inner member is formed with a rotation groove into which the fastening hook is inserted, and
wherein the rotation groove is formed along a periphery of the inner member so as to guide movement of the fastening hook during rotation of the outer member.

18. The adapter for a water filter according to claim 16,
wherein a coupling portion configured to be rotatably coupled to the head is formed on an outer surface of the outer member.

19. The adapter for a water filter according to claim 16,
wherein an operation portion configured for rotational operation of the outer member is provided on an outer surface of the outer member at a position located below the coupling portion.

20. The adapter for a water filter according to claim 19,
wherein the operation portion protrudes outward below the head, and
wherein a plurality of operation portions are formed radially with respect to a center of the outer member.
